(19) United States
(12) Patent Application Publication
(10) Pub. No.: US 2011/0001730 A1
(43) Pub. Date: Jan. 6, 2011

(54) ELECTRONIC PEN USING A SUPER CAPACITOR AS POWER SUPPLY

(75) Inventors: Jian ZHU, Shenzhen (CN); Jianzhong WU, Shenzhen (CN); Weihong LU, Shenzhen (CN); Jianhao LIN, Shenzhen (CN)

Correspondence Address: Locke Lord Bissell & Liddell LLP;Attn: IP Docketing, Three World Financial Center, New York, NY, 10281-2101, US

(73) Assignee: JULONG EDUCATIONAL TECHNOLOGY CO., LTD., Shenzhen (CN)

(21) Appl. No.: 12/830,091

(22) Filed: Jul. 2, 2010

(30) Foreign Application Priority Data
Jul. 6, 2009 (CN) 200910108482.1

(51) Int. Cl. G06F 3/033

(52) U.S. Cl. 345/179

(57) ABSTRACT

The present invention relates to an electronic pen using a super capacitor as a power supply which comprising a housing, a power supply, and a nib arranged at one end of the housing, a boosting circuit connected with the power supply for implementing a boosting process to an output voltage of the power supply based on an external triggering signal, an oscillation circuit for generating electromagnetic waves with different frequencies based on the voltage provided by the boosting circuit, wherein, the power supply is a super capacitor. By using a super capacitor as a power supply, the present invention brings no pollutions in the constitution of the raw material, and in the processes of production, using, storing and disassembling, so it is a perfect environmentally friendly power supply. Moreover, the super capacitor can be recycling used, so the cost is greatly reduced. Using the super capacitor as a power supply, the charging rate is fast, only several minutes even tens of seconds are needed for charging. In addition, the weight of the super capacitor is lighter than dry battery, so when it is arranged on an electrical pen, the writing will be more convenient and fluent. Simple charging and discharging circuit rather than complexity charging circuit needed by the traditional rechargeable battery is employed, so high safety factor may be obtained without maintenance for a long time.

### FIELD OF THE INVENTION

The present invention relates to an electronic pen, and more particularly, to an electronic pen using a super capacitor as a power supply.

### BACKGROUND OF THE INVENTION

An electronic pen is a pen for using on an electronic whiteboard or a handwritten panel. The existing electronic pen uses a dry battery or a rechargeable battery for power supply. The voltage provided by the dry battery or the rechargeable battery gets through the DC-DC boosting chip firstly. The enabling port of the DC-DC boosting chip is controlled by a key, and the DC-DC boosting chip only can be enabled when the nib or right key is pressed down. The voltage is elevated to 5V after being boosted by the DC-DC boosting chip, then the whole circuit works, so AC currents with different frequency are generated according to different keys on the electronic pen. The electronic pen locates on the electronic whiteboard or the handwritten panel by using electromagnetic induction through AC current with different frequency and generated in the coil thereof.

Following technical defects present in the existing electronic pen using a dry battery or a rechargeable battery for power supply. Potential pollution problems present after the usage of the dry battery and the rechargeable battery, and inconveniency may be brought in the transport and storage process of the product. Moreover, the whole weight of the electronic pen using a dry battery or a rechargeable battery for power supply is heavy, the charging time needed by the rechargeable battery is long and the charging times of the rechargeable battery is limited.

### SUMMARY OF THE INVENTION

One aspect of the present invention is overcoming the defects mentioned above and providing an electronic pen using a super capacitor as a power supply, which using a super capacitor for replacing the traditional dry battery or rechargeable battery to provide necessary electrical power, so as to achieve the purpose of energy saving and environmentally friendly.

The technical solution employed by the present invention for solving the technical problem thereof is constructing an electronic pen using a super capacitor as a power supply, which comprising a housing, a power supply, and a nib arranged at one end of the housing, a boosting circuit connected with the power supply for implementing a boosting process to an output voltage of the power supply based on an external triggering signal, an oscillation circuit for generating electromagnetic waves with different frequencies based on the voltage provided by the boosting circuit, wherein, the power supply is a super capacitor.

In the electronic pen using a super capacitor as a power supply, the capacitance value of the super capacitor is ≧0.5 F.

In the electronic pen using a super capacitor as a power supply, the super capacitor is arranged in the housing.

In the electronic pen using a super capacitor as a power supply, the super capacitor comprises a plurality of super capacitors connected in parallel.

In the electronic pen using a super capacitor as a power supply, the electronic pen further comprises a charging protection circuit used for quickly charging the super capacitor.

In the electronic pen using a super capacitor as a power supply, the charging protection circuit comprises a current limiting element and a voltage limiting element connected between an input charging voltage and the super capacitor in series.

In the electronic pen using a super capacitor as a power supply, the current limiting element is a current limiting resistor, and the voltage limiting element is a plurality of diodes co-phase connected in series.

In the electronic pen using a super capacitor as a power supply, the plurality of diodes co-phase connected in series comprises a first diode, a second diode, a third diode and a schottky diode, wherein, the anode of the first diode is connected with a positive terminal of the input charging voltage, the cathode of the first diode is connected with the anode of the second diode, the cathode of the second diode is connected with the anode of the third diode, the cathode of the third diode is connected with the anode of the schottky diode, and the cathode of the schottky diode is connected with the positive terminal of super capacitor, and the negative terminal of super capacitor is connected with the negative terminal of the input charging voltage.

In the electronic pen using a super capacitor as a power supply, the current limiting resistor is a variable resistor.

In the electronic pen using a super capacitor as a power supply, the electronic pen using a super capacitor as a power supply further comprises a startup/writing key and a right key arranged on the housing and used for generating the external triggering signal.

In the electronic pen using a super capacitor as a power supply, the super capacitor is arranged at the end of the housing opposite to the nib, and a pushing switch of the oscillation circuit is connected to the nib.

In the electronic pen using a super capacitor as a power supply, the electronic pen using a super capacitor as a power supply further comprises an electric quantity indicating circuit used for indicating the electric quantity stored by the super capacitor.

In the electronic pen using a super capacitor as a power supply, the electric quantity indicating circuit comprises an electric quantity receiving unit connected at the two terminals of the super capacitor for receiving voltage signal, and an electric quantity indicating lamp for indicating the electric quantity of the super capacitor based on the voltage signal received by the electric quantity receiving unit.

By using a super capacitor as a power supply, the present invention brings no pollutants in the constitution of the raw material, and in the processes of production, using, storing and disassembling, so it is a perfect environmental protecting power supply. Moreover, the super capacitor can be recycled, so the cost is greatly reduced. Using the super capacitor as a power supply, the charging rate is fast, and only several minutes even tens of seconds are needed for charging. In addition, the weight of the super capacitor is lighter than dry battery, so when it is arranged on an electrical pen, the writing will be more convenient and fluent. Simple charging and discharging circuit rather than complexity charging circuit needed by the traditional rechargeable battery is employed, so high safety factor may be obtained without maintenance for a long time. Accordingly, the present invention has prominent advantages of simple circuit structure, energy saving and environmentally friendly.

### BRIEF DESCRIPTION OF THE DRAWINGS

The following drawings illustrate preferred, but not exclusive embodiments of the inventions:

FIG. 1 is a schematic diagram of the electronic pen using a super capacitor as a power supply according to a first embodiment according to the present invention;

FIG. 2 is a schematic diagram of the electronic pen using a super capacitor as a power supply according to a second embodiment according to the present invention;

FIG. 3 is a circuit schematic diagram of the charging protection circuit of the electronic pen using a super capacitor as a power supply according to an embodiment according to the present invention.

### DETAILED DESCRIPTION OF THE PREFERRED EMBODIMENT

These and other advantages, aspects and novel features of the present invention, as well as details of an illustrated embodiment thereof, will be more fully understood from the following description and drawings. While various embodiments of the present invention have been presented by way of example only, and not limiting.

The present invention is based on the principle that a super capacitor may store and discharge a certain amount of energy, the charging and discharging processes of the super capacitor is always a physical process, and has advantages such as no chemical reaction, safer material, and shorter charging time. In such a way, the defects such as the traditional dry battery cannot be used time after time, serious pollution to the environment will be produced after the traditional battery is discarded, the long charging time and heavy weight of the traditional rechargeable battery. Accordingly, the traditional dry battery source or rechargeable battery source can be replaced by the super capacitor which is portability, environmentally friendly, shorter charging time and recyclable. Moreover, charging protection also realized in the circuit of the present invention.

As shown in FIG. 1, the electronic pen using a super capacitor as a power supply comprises a housing (not shown), and a nib (not shown) arranged at one end of the housing and a super capacitor 2 used as a power supply. The electronic pen using a super capacitor as a power supply further comprises a boosting circuit 3 and an oscillation circuit 6. Wherein, the boosting circuit 3 is connected to the super capacitor 2, and implementing a boosting process to an output voltage of the super capacitor 2 based on an external triggering signal. The oscillation circuit 6 is connected with the boosting circuit 3, so as to generate electromagnetic waves with different frequencies based on the voltage provided by the boosting circuit 3. In a preferable embodiment of the present invention, the electromagnetic waves can be sine electromagnetic waves.

In a preferable embodiment of the present invention, the capacitance value of the super capacitor is rather big, and is always above or equal to 0.5 F. In another preferable embodiment of the present invention, the capacitance value of the super capacitor is always above or equal 1 F. In another preferable embodiment of the present invention, the super capacitor comprises a plurality of super capacitors connected in parallel so as to further enlarge the capacitance value.

In the present invention, the diameter of super capacitor is smaller than the diameter of the housing, so the super capacitor may arranged at any place inside the housing. In a preferable embodiment of the present invention, the super capacitor 2 is arranged at the end of the housing opposite to the nib.

In one embodiment of the present invention, the oscillation circuit 6 may generate electromagnetic waves with three different frequencies for indicating the cursor state, writing state, and right key state based on the voltage provided by the boosting circuit 3. In another embodiment of the present invention, the external triggering signal may come from a user triggering key, a button, even a touching screen. One skilled in the art may be aware of different arrangement of various keys, buttons, and touching screens, so no further description is provided for concision.

In a preferable embodiment of the present invention, the oscillation circuit 6 is a LC serially and parallel connected oscillation circuit comprising a plurality of capacitors and inductors for generating AC current with different frequencies through the control of the boosting circuit 3, so as to locate on the electronic whiteboard or the handwritten panel. In the present invention, any boosting circuit and oscillation circuit known in present field can be used in the present invention, only if they can satisfy the requirement of the present invention. Accordingly, the present invention will not be limited by the type of the boosting circuit and oscillation circuit.

The work principle of the electronic pen using a super capacitor as a power supply according to the present invention is listed as follows. When writing, the coils in the electrical pen are functioning on the net wire of the sensor on the electrical whiteboard through the variable magnetic field generated by the AC current, which is equivalent to that there is a variable magnetic field inside the coil of the sensor. Then according to the electromagnetic induction principle, inducting current is generated in the net wire of the sensor on the electrical whiteboard, then writing location can be implemented though a series of hard and soft process. In such process, the function of the electrical pen is for generating changeable magnetic field, which requires the inductor in oscillation circuit 6 to generate AC current with three different frequencies. In the present invention, the super capacitor 2 controls the oscillation circuit 6 to generate AC current with three different frequencies in the inductance coil in the electrical pen through the boosting circuit 3.

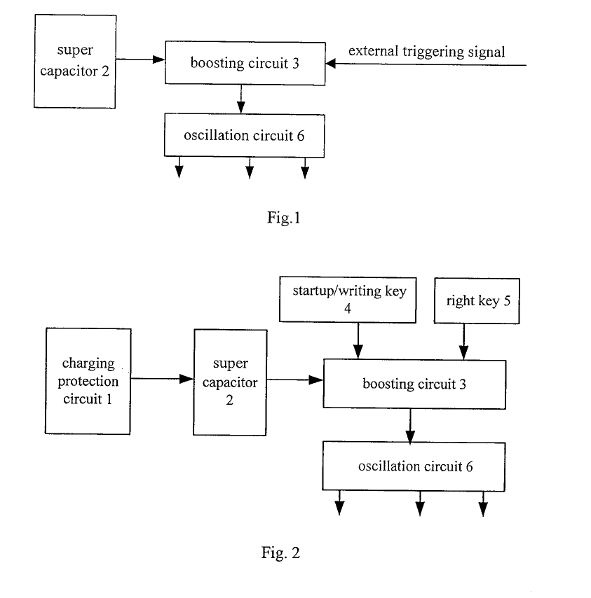

FIG. 2 is a schematic diagram of the electronic pen using a super capacitor as a power supply according to a second embodiment according to the present invention. As shown in FIG. 2, in the preferable embodiment of the present invention, the electronic pen using a super capacitor as a power supply further comprises a charging protection circuit 1, a startup/writing key 4 and a right key 5. Wherein, the charging protection circuit 1 is connected between the super capacitor 2 and the charging voltage inputted from outside, so as to quickly charge the super capacitor 2. In a preferable embodiment of the present invention, the charging protection circuit 1 comprises a current limiting element and a voltage limiting element connected between an input charging voltage and the super capacitor 2 in series. The current limiting element is a current limiting resistor, and the voltage limiting element is a plurality of diodes co-phase connected in series. Accordingly, when the electricity quantity of the super capacitor 2 is insufficient, the charging protection circuit 1 can be used for quickly charging the super capacitor 2. The charging time depends on the size of the charging current and the capacity of the super capacitor 2. The charging protection circuit 1 should guarantee that the voltage value of the super capacitor 2 should never exceed the highest voltage permitting value thereof. If the highest voltage permitting value is exceeded, the performance of the super capacitor 2, such as the capacitance value, leakage current, and impedance will degrade quickly. Accordingly, the charging protection circuit 1 is preferable for guaranteeing that the voltage value of the super capacitor 2 should never exceed the highest voltage permitting value thereof when charging. Of course, in a simple embodiment of the present invention, the electronic pen using a super capacitor as a power supply according to the present invention may not comprise the charging protection circuit 1 in a condition that the charging voltage is stable and never goes beyond the highest voltage permitting value of the super capacitor 2.

The startup/writing key 4 and the right key 5 are arranged on the housing so as to receive an external trigger from the user, and generate an external triggering signal which will be sent to the boosting circuit 3. Now further instruction is made to the electronic pen using a super capacitor as a power supply by combining the charging protection circuit 1, the startup/writing key 4 and the right key 5.

When the super capacitor 2 is fully charged and used as a power supply, the voltage output by the super capacitor 2 is elevated by the boosting circuit 3 to a needed voltage value. Of course, the electrical pen is not always in a working state, so the startup and switching off of the boosting circuit 3 is controlled by the startup/writing key 4 and the right key 5. When the startup/writing key 4 or the right key 5 is pressed down, the boosting circuit 3 is startup to work normally. A pushing switch of the oscillation circuit 6 is connected to the nib. When writing, the oscillation circuit 6 generates oscillation currents with three different frequencies according to the triggering of the keys. If the startup/writing key 4 is pressed down, the oscillation circuit 6 generates oscillation currents with a frequency of 254 KHz, and when it is used cooperatively with the electrical whiteboard, a function of the cursor state is provided. If the startup/writing key 4 is pressed down for a long time, the oscillation circuit 6 generates oscillation currents with a frequency of 262 KHz, and when it is used cooperatively with the electrical whiteboard, a function of the writing state is provided, and the electrical pen is always in a working state. If the right key 5 is pressed down, the oscillation circuit 6 generates oscillation currents with a frequency of 235 KHz, and when it is used cooperatively with the electrical whiteboard, a function of the right key state is provided.

One skilled in the art may know the cursor state, the writing state and the right key state listed above is the operation states of the electrical pen commonly known by one skilled in the art. In another embodiment of the present invention, one skilled in the art may combine the super capacitor 2 with other oscillation circuits with various states so as to produce more operation states of the electrical pen according to the teaching of the present invention.

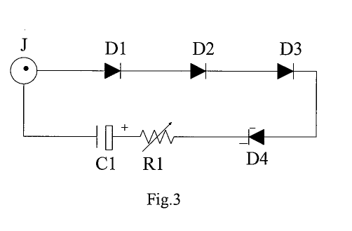

FIG. 3 is a circuit schematic diagram of the charging protection circuit of the electronic pen using a super capacitor as a power supply according to an embodiment according to the present invention. FIG. 3 shows a specific circuit schematic diagram of the charging protection circuit 1. As shown in FIG. 3, the charging protection circuit 1 comprises a resistor R1, a first diode D1, a second diode D2, a third diode D3 and a schottky diode D4. Reference number J refers to a charging interface of a +5V power supply. Such charging interface J is connected with an input charging voltage (such as, a 5V power supply of a whiteboard) for charging. Wherein, the anode of the first diode D1 is connected with the charging interface J for connecting a positive terminal of the input charging voltage, the cathode of the first diode D1 is connected with the anode of the second diode D2, the cathode of the second diode D2 is connected with the anode of the third diode D3, the cathode of the third diode D3 is connected with the anode of the schottky diode D4, and the cathode of the schottky diode D4 is connected with the positive terminal of super capacitor C1 through the current limiting resistor R1, and the negative terminal of super capacitor C1 is connected with the charging interface J for connecting the negative terminal of the input charging voltage. In another preferable embodiment of the present invention, the current limiting resistor R1 is a changeable resistor.

Through the voltage reducing function of the diodes, the voltage applied on the two terminals of the super capacitor C1 is limited to about 2.6V, and never goes beyond the highest voltage permitting value of 2.7V. The current limiting resistor R1 is a changeable resistor. By adjusting the resistance value of the changeable resistor R1, the charging current can be controlled, so as to determine the charging time of the super capacitor C1. As diodes have been employed for voltage reducing, the voltage applied on the two terminals of the super capacitor C1 is kept below the highest voltage permitting value of 2.7V, and the current will not flow back, so the super capacitor C1 can be protected.

In another alternative embodiment of the present invention, one or more schottky diodes may be used. One skilled in the art may arrange different amount of diodes according to actual requirement. In the present invention, charging interface J may arrange at any place on the housing and one skilled in the art may arrange the charging interface anywhere according to actual requirement.

In another preferable embodiment of the present invention, the electronic pen using a super capacitor as a power supply further comprises an electric quantity indicating circuit used for indicating the electric quantity stored by the super capacitor. Wherein, the electric quantity indicating circuit comprises an electric quantity receiving unit connected at the two terminals of the super capacitor for receiving voltage signal, and an electric quantity indicating lamp for indicating the electric quantity of the super capacitor based on the voltage signal received by the electric quantity receiving unit. The electric quantity indicating lamp may be a LED lamp that is arranged on the housing.

In summary, the present invention is based on the principle that a super capacitor may store and discharge a certain amount of energy, the charging and discharging processes of the super capacitor is always a physical process, and has advantages such as no chemical reaction, safer material, and shorter charging time. In such a way, the defects such as the traditional dry battery cannot be used time after time, serious pollution to the environment will be produced after the traditional battery is discarded, the long charging time and heavy weight of the traditional rechargeable battery. Accordingly, the traditional dry battery source or rechargeable battery source can be replaced by the super capacitor which is portability, environmentally friendly, shorter charging time and recycling usable. Moreover, charging protection also realized in the circuit of the present invention.

The foregoing description is just the preferred embodiment of the invention. It is not intended to limit the invention. Any modifications, variations, and amelioration without departing from the spirit and scope of the present invention should be included in the scope of the present invention.

1. An electronic pen using a super capacitor as a power supply, which comprises a housing, a power supply, and a nib arranged at one end of the housing, a boosting circuit connected with the power supply for implementing a boosting process to an output voltage of the power supply based on an external triggering signal, an oscillation circuit for generating electromagnetic waves with different frequencies based on the voltage provided by the boosting circuit, wherein, the power supply is a super capacitor.

2. The electronic pen using a super capacitor as a power supply according to claim 1, wherein, the capacitance value of the super capacitor is ≧0.5 F.

3. The electronic pen using a super capacitor as a power supply according to claim 1, wherein, the super capacitor is arranged in the housing.

4. The electronic pen using a super capacitor as a power supply according to claim 1, wherein, the super capacitor comprises a plurality of super capacitors connected in parallel.

5. The electronic pen using a super capacitor as a power supply according to claim 1, wherein, the electronic pen using a super capacitor as a power supply further comprises a charging protection circuit used for quickly charging the super capacitor.

6. The electronic pen using a super capacitor as a power supply according to claim 5, wherein, the charging protection circuit comprises a current limiting element and a voltage limiting element connected between an input charging voltage and the super capacitor in series.

7. The electronic pen using a super capacitor as a power supply according to claim 6, wherein, the current limiting element is a current limiting resistor and the voltage limiting element is a plurality of diodes co-phase connected in series.

8. The electronic pen using a super capacitor as a power supply according to claim 7, wherein, the plurality of diodes co-phase connected in series comprises a first diode, a second diode, a third diode and a schottky diode, wherein, the anode of the first diode is connected with a positive terminal of the input charging voltage, the cathode of the first diode is connected with the anode of the second diode, the cathode of the second diode is connected with the anode of the third diode, the cathode of the third diode is connected with the anode of the schottky diode, and the cathode of the schottky diode is connected with the positive terminal of super capacitor, and the negative terminal of super capacitor is connected with the negative terminal of the input charging voltage.

9. The electronic pen using a super capacitor as a power supply according to claim 8, wherein, the current limiting resistor is a variable resistor.

10. The electronic pen using a super capacitor as a power supply according to claim 1, wherein, the electronic pen using a super capacitor as a power supply further comprises a startup/writing key and a right key arranged on the housing and used for generating the external triggering signal.

11. The electronic pen using a super capacitor as a power supply according to claim 1, wherein, the super capacitor is arranged at the end of the housing opposite to the nib, and a pushing switch of the oscillation circuit is connected to the nib.

12. The electronic pen using a super capacitor as a power supply according to claim 1, wherein, the electronic pen using a super capacitor as a power supply further comprises an electric quantity indicating circuit used for indicating the electric quantity stored by the super capacitor.

13. The electronic pen using a super capacitor as a power supply according to claim 12, wherein, the electric quantity indicating circuit comprises an electric quantity receiving unit connected at the two terminals of the super capacitor for receiving voltage signal, and an electric quantity indicating lamp for indicating the electric quantity of the super capacitor based on the voltage signal received by the electric quantity receiving unit.
